(19) United States
(12) Patent Application Publication
(10) Pub. No.: US 2021/0049600 A1
(43) Pub. Date: Feb. 18, 2021

(54) Digital Asset Delivery Network

(71) Applicant: Qredo Ltd., London (GB)

(72) Inventors: Brian Spector, London (GB); Chris Morris, Epping (GB); Howard Kitto, Hampshire (GB); Kelan McCusker, Dublin (IE)

(73) Assignee: Qredo Ltd., London (GB)

(21) Appl. No.: 17/085,687

(22) Filed: Oct. 30, 2020

Related U.S. Application Data
(63) Continuation-in-part of application No. 16/415,113, filed on May 17, 2019.
Application No. 16/415,113 is a continuation-in-part of application No. 16/410,703, filed on May 13, 2019.
Application No. 16/410,703 is a continuation-in-part of application No. 16/410,656, filed on May 13, 2019.
Application No. 16/410,656 is a continuation-in-part of application No. 62/673,706, filed on May 18, 2018.
(60) Provisional application No. 62/928,898, filed on Oct. 31, 2019.
(60) Provisional application No. 62/834,553, filed on Apr. 16, 2019.
(60) Provisional application No. 62/824,849, filed on Mar. 27, 2019.

(51) Int. Cl. G06Q 20/38; H04L 9/32; G06Q 20/36; H04L 9/08

(52) U.S. Cl. CPC G06Q 20/3829; H04L 9/3247; H04L 2209/56; H04L 9/0825; H04L 2209/38; G06Q 20/36

(57) ABSTRACT

A digital asset delivery network that consists of a cryptographic scheme and a decentralized network that runs on a blockchain. The decentralized network consists of a computer program that interact with the network by issuing electronic messages, computer programs that validate those messages as entries into blockchain and agree on blocks to publish next, and computer programs that run cryptographic multi-party computation protocols. The multi-party computation protocol generates public keys necessary to create cryptocurrency or crypto asset wallets, and also generates the digital signatures necessary to create a transaction for submission to the crypto asset's underlying decentralized network and blockchain.

### PRIORITY CLAIM

This application is a nonprovisional continuation of U.S. Pat. App. No. 62/928,898 filed on Oct. 31, 2019. This application also claims priority as a continuation-in-part to U.S. patent application Ser. No. 16/415,113 filed May 17, 2019, which claims priority as a non-provisional continuation of U.S. Prov. App. 62/673,706 filed May 18, 2018; U.S. patent application Ser. No. 16/410,703 filed May 13, 2019, which claims priority to as a non-provisional continuation of U.S. Provisional Pat. App. No. 62/832,4553, filed on Apr. 16, 2019, and U.S. Prov. Pat. App. 62/824,849 filed on Mar. 27, 2019; and U.S. patent application Ser. No. 16/410,656 filed May 13, 2019 which are all hereby incorporated by reference in their entireties for all they teach.

### FIELD OF INVENTION

A digital asset delivery network that consists of a cryptographic scheme and a decentralized network that runs on a blockchain or other cryptographic distributed registry.

### SUMMARY OF INVENTION

The invention is a digital asset delivery network. The invention pertains generally to cryptocurrencies and tokenized digital assets. Tokenization is a method that converts rights to an asset (real estate, stocks, bonds) into a scarce or worldly unique digital token, known generally and broadly as ‘crypto assets’. Crypto assets rely on public key cryptography. Specifically, a secret known as a private key corresponds to an wallet address which acts as a virtual container for the crypto assets. Knowledge of the private key equates to having the ability to transact on all crypto assets within the wallet. This method is applicable for both cryptocurrencies and more broadly, crypto assets.

Specifically, the invention relates to a cryptographic scheme and decentralized network of computers running a blockchain that enables the transfer of crypto assets between parties without it being necessary to create a transaction on those crypto assets' underlying blockchains. Further, the invention removes the burden of managing, storing and safeguarding private keys for any user of the invention.

The invention possesses numerous advantages over known methods of safeguarding crypto assets, and of other types of networks whose purpose is to create an alternative ‘side-chain’ to a crypto asset's underlying blockchain in order to move crypto assets from one party to another. In particular, the invention utilizes a multi-party computation protocol to remove the need for a user to rely on a third party or themselves to securely store and safeguard private keys for the user of the invention. The presence of private keys creates a risk of financial loss if private keys are compromised, and significant operational burdens and costs to crypto asset owners to safeguard those private keys from compromise. Further, the invention implements a cryptographic scheme consisting of aggregated cryptographic digital signatures and cryptographic public keys in conjunction with its own decentralized network and blockchain, so that the ownership of the crypto asset's wallet can be transferred between users of the invention. This transfer is confirmed on the invention's own blockchain in seconds, compared to the many minutes it takes for transactions to confirm on mainstream crypto asset blockchains such as Ethereum™ or Bitcoin™. The result is that crypto assets can be traded between parties in a way that makes the transfer and delivery of crypto assets nearly instant and very secure. Final settlement stays on the crypto asset's underlying blockchain so crypto assets, including cryptocurrencies, tokens representing shares, etc., can be traded between users of the invention an unlimited number of times without performing final settlement on the crypto asset's native blockchain. This realizes a significant reduction in transfer costs and a significant increase in speed of transfer.

In addition to the foregoing attributes, the design of the invention possesses numerous other benefits over conventional cybersecurity approaches to private key safeguarding. A practical advantage of the cryptographic scheme within the invention is that it enables users to set up other users of the invention to act as ‘Trustees’ over the wallets, specifically when it comes to creating a transaction on the underlying crypto asset's blockchain (i.e., a transaction on the bitcoin blockchain), transferring the wallet to another user of the invention (without settling on the underlying asset's blockchain), or enabling another user of the invention to be able to get a cryptographic proof of the assets contained within the wallet without accessing the private key that controls the wallet. A Trustee's role is to approve, or not approve, a user's requests to undertake these actions. These Trustee relationships are cryptographically enforced on the invention's blockchain which also serves as an immutable (unchangeable) record that organizations or individuals tasked with regulatory compliance or law enforcement can refer to with confidence. The practical benefit of this capability is that users of the invention can remain in good legal standing with their local regulatory regimes.

Another practical advantage over current methods of safeguarding crypto assets is that a wallet owner can elect to run a protocol, subject to trustee's approval, that enables the wallet owner to cryptographically verify to any other user what crypto assets (type and amount) are in the wallet, without accessing the private key that controls the wallet. Current approaches to disclosing assets involve accessing a private key, creating security risks.

The invention provides another advantage for users in that multiple crypto assets using different blockchains (example: Ethereum and Bitcoin) can be swapped between multiple parties in one transaction. The field of use is called an ‘atomic swap’. An atomic swap is an exchange of one set of crypto assets for another without using centralized intermediaries, such as exchanges.

Lastly, the invention provides another advantage in that the transfers of crypto assets on its chain are private, and do not leak any information about the underlying assets being transferred or who the users of the invention are outside of the participants involved in the transaction or atomic swap.

It can thus be seen that the present invention provides a decentralized crypto asset transfer and delivery network that is secure from private key theft because no private keys are required to transact. Ownership and transfer of ownership is recorded and enforced on its blockchain. Submitting cryptographic proof of possession of a wallet containing crypto assets to another user of the invention, and transferring the wallet to another user, can be done in a way that is faster, and less costly, than doing the transfer on the crypto asset's underlying blockchain. Multiple assets can be traded and transferred simultaneously using atomic swaps, delivering savings in cost and complexity for users. Lastly, privacy is built into the invention so information about who users are or what assets have been transferred remains secured between the users conducting the transaction.

### DESCRIPTION OF THE FIGURES

The headings provided herein are for convenience only and do not necessarily affect the scope or meaning of the claimed invention. In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced (e.g., element 204 is first introduced and discussed with respect to FIG. 2).

FIG. 1 is a view of the operations of the multi-party computation protocol between a client and a server in a 2 out of 2 threshold scheme. The operations listed produce a public key (steps 1-9), from which the generation of a cryptocurrency wallet address is formed.

FIG. 2 is a continuation of the operations of the multi-party computation protocol between the client and server that ends with the production of the digital signature.

FIG. 3 is an overview of the invention including its network, MPC Node (server), Client and Validator Node.

FIG. 4 is a description of the sequential steps a user (a sender) who is transferring digital assets through the invention's network performs.

FIG. 5 is a description of the 1st public message and its included parts created by the sender that is written into the blockchain.

FIG. 6 is a description of the 2nd public message and its included parts created by the sender that is written into the blockchain.

FIG. 7 is a description of the encrypted messages that are created by the Sender for Trustees. These messages, although encrypted, are also written into the blockchain. These messages setup both the Proof of Reserves protocol and the mechanism to approve the transfer of a Transaction Right.

FIG. 8 is an overview of the message structure and flow from sender to Trustee(s) to recipient of the Transaction Right starting from a sender requesting Proof of Reserves to a Trustee approving it to a recipient receiving it.

FIG. 9 is a description of the steps taken by the potential recipient of the transaction right when they run the Proof of Reserves protocol.

FIG. 10 is a description of the steps taken by a sender when they start the process of creating a Transfer Message over a Transaction Right. A sequence of validated Transfer and Accept Messages is one half of the process necessary for transfer of the Transaction Right from the sender to the recipient to be recognized as valid by other nodes in the network.

FIG. 11 is a description of the Transfer Message created by the sender and its included parts. The Transfer Message is created by the sender and written into the blockchain.

FIG. 12 is a description of the steps taken by a recipient of the Transaction Right when they start the process of creating an Accept Message confirming their acceptance of a received Transaction Right.

FIG. 13 is a description of the Accept Message created by the recipient and its included parts. The Accept Message is created by the recipient and written into the blockchain.

FIG. 14 is an overview of the sequence of steps and messages that a sender of a Transaction Right performs to invoke its Trustees to approve the transfer. The Trustees approve a transfer by writing into the blockchain their own sequence of messages. A sequence of validated Approval Messages from Trustees is the second half of the process necessary for transfer of the Transaction Right from the sender to the recipient to be recognized as valid by other nodes in the network.

FIG. 15 is a description of the Approval Message(s) created by the Trustee(s) and its included parts. The Approval Message(s) are created by the Trustee(s) and written into the blockchain.

FIG. 16 is an overview of the overall message sequence involved in the transfer of a Transaction Right. Also shown is the signature aggregation and verifications needed in order for an MPC Node (Server) to recognize as valid a transfer of a Transaction Right.

### DETAILED DESCRIPTION

Various examples of the invention will now be described. The following description provides specific details for a thorough understanding and enabling description of these examples. One skilled in the relevant art will understand, however, that the invention may be practiced without many of these details or based on variations of the details. Likewise, one skilled in the relevant art will also understand that embodiments of the invention can be accompanies with other features not described in detail herein. Additionally, some well-known structures or functions may not be shown or described in detail below, so as to avoid unnecessarily obscuring the relevant description. References to Qredo are the name of a service that has implemented the invention. The Qredo Server executes the server processes in accordance with the invention and the Qredo App can execute either the principal, beneficiary or fiduciary processes.

### BACKGROUND

BLS Signature Scheme

At a high level, BLS Signatures are a short signature scheme based on the computational Diffie-Hellman assumption on certain elliptic and hyper-elliptic curves (“BLS Signatures”).

The BLS signature (Boneh-Lynn-Shacham) scheme makes use of pairing cryptography to generate very short signatures that can be just the x coordinate of a point Pϵ1. Working in an elliptic curve group provides some defense against index calculus attacks (with the caveat that such attacks are still possible in the target group G_{T} of the pairing), allowing shorter signatures than other systems for similar levels of security.

BLS signatures have become the subject of much work as they are seen as a possible way forward to solve privacy issues within cryptocurrencies through a process of signature aggregation. The invention implements a multi-signature with public-key aggregation scheme overlay with an t-of-n threshold scheme.

In a simple example, given a secret key sk, a public key pk=g^{Sk}, a message m, a hashing-into-the-curve function H, and a bilinear pairing e:
Key Generation: sk is a random integer over the field, pk=g^{Sk}
Signature: S=H(m)^{ab}
Verify: e(H(m),pk)=e(S,g)
Bilinarity is evident as the signature:
   e(H(m),pk)=e(H(m),g^{sk})=e(H(m),g)^{sk}==e(H(m)^{sk},g)=e(S,g)
      but is also unique and deterministic.

### BLS MSP Scheme

The invention utilizes a pairing-based multi-signature scheme with public-key aggregation MSP based on BLS signatures with formal security proof processes The scheme is secure in the public key model and assumes the hash functions H₀:{0, 1}*→G₂ and H₁:{0, 1}*→Z_{q}.
Parameter Generation. Pg(κ) sets up bilinear group (q, G₁, G₂, Gᵢ, e, g₁, g₂)←G(κ) and outputs par←(q, G₁, G₂, Gᵢ, e, g₁, g₂)
Key Generation, The algorithm Kg(par) chooses sk [symbol] Z_{q} to compute pk←g₂^{sk}, and outputs (pk,sk).
Key Aggregation. KAg({pk₁, . . . , pkₙ}) outputs

$$apk ← {\prod }_{i = 1}^{n} {pk}_{i}^{{H}_{1}} ( {pk}_{i} , ( {pk}_{1} , … , {pk}_{n} \} ) .$$

Signing. Signing is a single round protocol. Sign(par,{pk₁, . . . , pkₙ}, skᵢ,m) computes sᵢ←H₀(m)^{a}^{ᵢ}^{,sk}^{ᵢ}, where aᵢ←H₁(pkᵢ, {pk₁, . . . , pkₙ}). In the case of the invention, the client acts as the protocol's designated combiner to computer the final signature as σ←Πⱼ₌₁ⁿsⱼ.
Multi-signature Verification. V f(par, apk, m, σ) outputs 1 iff e(σ, g₂⁻¹)·e(H_{O}(m), apk) [symbol] 1_{G},

### BLS Threshold Signature Scheme

This is a t-of-n threshold scheme for a Secret Sharing process and the BLS scheme. The scheme exploits a BLS property whereby it is possible to aggregate all types of BLS scheme primitives (secret keys, public keys, signatures) and the result is always another valid primitive. For example, if you aggregate two secret keys, the result is a new valid secret key. If you aggregate the two corresponding public keys of the secret keys, the result is a new public key that matches the previously aggregated secret key's public key. If you aggregate two signatures that were created with the two previously aggregated secret keys and the same message hash, the new signature would also validate against the aggregated public key. Primitives which were already aggregated can also be further aggregated, independent from the order in which it happens.

This property can even be generalized. On any given set of secret key, public key and signature tuples, for any operation performed on one of the primitives, it is possible to repeat the same operation on the other primitives and obtain a new tuple where the primitives still correlate to each other.

BLS Signatures are unique and deterministic. Meaning that for any given pair of public key and message, there can only be one valid signature. It's not possible to have two different signatures validating against the same public key and message. In fact, almost every operation performed on a BLS primitive is deterministic. If an operation with the same inputs, e.g. create a signature from a pair of secret key and message hash, the resulting signature will always be the same. The determinism even holds if operations are nested and complex.

When a BLS secret key is generated a computer program splits it into a threshold group using the above Secret Sharing, and then distributes to other entities, the resulting shares of that secret key are also valid secret keys themselves, which can be used to sign a message and thus create a valid signature. These signatures are signature shares and only validate against the public key of the secret key ‘share’. An aspect of the invention acts as a signature combiner in this instance to take t-of-n of these signatures generated by the other entities who possess these secret shares, and perform the same polynomial interpolation as would be done usually do with the secret shares. This recovers a signature which is identical to what would have been created if the original secret key had been used. This is only possible due to the properties described in the previous section.

Note that in describing the scheme, we first note the co-CDH (computational Diffie-Hellman) problem, given g₂, g^{a}₂ϵG₂ and hϵG₁ as input, one must compute haϵG1. For the co-DDH (decision Diffie-Hellman) problem, given g2, gaϵG2 and h, hbϵG1 as input, one must output “yes” if a=b, “no” otherwise. When the answer is “yes” (g₂, g^{a}₂, h, h^{b}) it is called a co-Diffie-Hellman tuple. A gap co-Diffie-Hellman group pair is a pair of groups (G₁, G₂) on which the co-DDH is easy but the co-CDH is hard.

Let E/F_{q} be an elliptic curve over the finite field F_{q} and P a point of prime order p, where p does not divide q(q−1) and p² does not divide |E(F_{q})|. Let also a>1 be a security multiplier and a<p. Then there exists a point Q linearly independent of p. With such points P, Q as generators we set G₁=<P>, G₂=<Q>. Then the Weil Pairing on the curve E gives a computable, non-degenerate bilinear map e:G₁×G₂→F*a^{a}, which enables us to solve the co-DDH problem on the group pair (G1, G2). Weil Pairing is described in Alfred J. Menezes. Elliptic Curve Public Key Cryptosystems. Kluwer Academic Publishers, Norwell, Mass., USA, 1994. ISBN 0792393686, which is incorporated by reference.

Key Generation. Pick a random sϵZₚ and compute V←ₛQ. Public key is VϵE (F_{qa}) and the private key is s.

Signature Generation. Given a private key sϵZp and a message μ, we compute R←H^{˜} (m)ϵG₁ and σ←sRϵE (F_{q}). H^{˜} is a hash function that maps a message μϵ{0, 1}* to an element of the group G₁.

Signature Verification. Given the public key VϵG₂, a message μϵ{0, 1}* and a signature σϵE (Fq) we must verify if (Q, V, R, σ) is a co-Diffie-Hellman tuple, i.e. if e(σ, Q)=e(R, V). The signature scheme described above provides a way we can build a non-interactive threshold BLS signature scheme based on the Secret Sharing described above and polynomial interpolation. The actors are a group of n parties P={P₁, P₂, . . . , Pₙ} up to t of which may be corrupted and a trusted dealer Dϵ/P.

Key Generation by Trusted Dealer. The trusted dealer generates a public—secret key pair (s, V), V=sQ, where s is a random element in Zp and VϵG₂, the same as for the non-threshold scheme. Also, the dealer constructs a random polynomial αϵZₚ of degree t, such that α(0)=s. The secret key share is

aᵢ=α(i),i=1, . . . ,n

Also the dealer calculates n public key share values

Vᵢ=sᵢQ,i=1, . . . ,n

that serve as verification keys.

Signature Share Generation. Given a message μϵ{0, 1}* and the secret key share sᵢ ϵZₚ, the message is mapped to G₁, as before, with a hash function R←H^{˜}(μ) and the signature share is calculated as

σᵢ=sᵢRϵG₁

Signature Share Verification. The signature share verification is equivalent to the signature verification. Given a message μϵ{0, 1}*, a signature share σᵢϵG₁ and the verification key ViϵG₂ the prover must verify that (Q, Vi, H (m), σi) is a co-Diffie-Hellman tuple. Q is the generator of the group G₂, which is a public parameter of the system, and is the hash function that maps the message μ to an element R in G1. If the verification is successful, σᵢ is a valid signature share of the party Pᵢ.

Signature Share Combination. To get the signature σ we need to collect at least t valid signature shares. Let S={i1, i2, . . . , it} be the set of indices of the collected signature shares. Then the signature is reconstructed by the equation

$$σ = {\prod }_{i ∈ 𝒮} {σ}_{i}^{{λ}_{i}}$$

where

$${λ}_{i} = \frac{{\prod }_{j ∈ 𝒮 \backslash \{ i \}} 0 - j}{{\prod }_{j ∈ 𝒮 \backslash \{ i \}} i - j} ,$$

are the Lagrange coefficients.

Signature Share Combination Verification. Given a message μϵ{0, 1}*, the signature σϵG1 and the public key VϵG2 the prover must verify that (Q, V, H^{˜}(μ), σ) is a co-Diffie-Hellman tuple. Q is the generator of the group G₂, which is a public parameter of the system, and H^{˜} is the hash function that maps the message μ to an element R in G1.

Multi-Party Computation Protocol with Trustless Setup

A threshold signature scheme can enable distributed digital signature generation among n players such that any subgroup of size t+1 can sign, whereas any group with t or few players cannot. In regards to digital assets, a threshold signature scheme enables n parties to share the power to issue digital signatures under a single public key. A threshold t is specified such that any subset of t+1 players can jointly sign, but any smaller subset cannot. Generally, the goal is to produce signatures that are compatible with an existing centralized signature scheme. In a threshold scheme the key generation and signature algorithm are replaced by a communication protocol between the parties, but the verification algorithm remains identical to the verification of a signature issued by a centralized party.

The invention utilizes this multi-party computation (MPC) protocol to produce signatures through the interaction of the computer programs that create messages on the network interacting with the computer programs that are responsible for the running the multi-party computation protocol specifically. Note that any suitable multi-party computation protocol exhibiting these properties may be used within the invention.

Threshold Decryption without Trusted Dealer

The invention utilizes a threshold decryption scheme run collectively by the computer programs responsible for running the multi-party computation protocol. Threshold decryption in a public key cryptosystem with n parties means a minimal number of parties is required to decrypt a ciphertext and excludes the situation where a single party (holding the decryption key) is able to decrypt all sensitive information.

The invention utilizes the threshold decryption scheme exclusively by the computer programs that are responsible for running the multi-party computation protocol as a way of securing the cryptographic primitives and secrets that enable them to run the MPC protocol with other computer programs that make up the invention. Note that any suitable threshold decryption scheme exhibiting these properties may be used within the invention.

The following articles are incorporated by reference: Dan Boneh, Ben Lynn, and Hovav Shacham. Short signatures from the weil pairing. Journal of Cryptology, 17:297-319, 2004; Dan Boneh, Manu Drijvers, and Gregory Neven. Compact multi-signatures for smaller blockchains. Cryptology ePrint Archive, Report 2018/483, 2018; Rosario Gennaro and Steven Goldfeder. Fast multiparty threshold ecdsa with fast trustless setup. In Proceedings of the 2018 ACM SIGSAC Conference on Computer and Communications Security, CCS '18, pages 1179-1194, New York, N.Y., USA, 2018. ACM. ISBN 978-1-4503-5693-0. doi: 10.1145/3243734.3243859; Alfred J. Menezes. Elliptic Curve Public Key Cryptosystems. Kluwer Academic Publishers, Norwell, Mass., USA, 1994. ISBN 0792393686; Pascal Paillier. Public-key cryptosystems based on composite degree residuosity classes. In Proceedings of the 17th International Conference on Theory and Application of Cryptographic Techniques, EUROCRYPT'99, pages 223-238, Berlin, Heidelberg, 1999. Springer-Verlag. ISBN 3-540-65889-0; Adi Shamir. How to share a secret. Commun. ACM, 22(11):612-613, November 1979. ISSN 0001-0782. doi: 10.1145/359168.359176; Chrysoula Stathakopoulou and Christian Cachin. Threshold signatures for blockchain systems. IBM Research Report, 2017; Thijs Veugen, Thomas Attema, and Gabriele Spini. An implementation of the paillier crypto system with threshold decryption without a trusted dealer. Cryptology ePrint Archive, Report 2019/1136, 2019.

### DETAILED DESCRIPTION

The invention pertains to a cryptographic scheme and decentralized network. Three computer programs run on the decentralized network. One computer program interacts with the network by issuing electronic messages. This computer program is commonly referred to as a ‘client’. Users of the invention will run this computer program, henceforth referred to as the ‘Client Node’, and it may scale up to millions of users running millions of instances of just as any other decentralized network in successful operation.

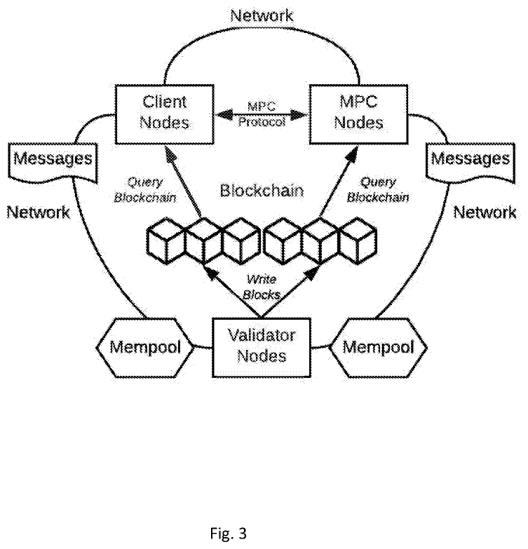

Another computer program validates those messages as entries to be written into the inventions blockchain and agree on blocks to publish next. These computer programs are called Validator Nodes.
The third computer program runs the multi-party computational (MPC) program to generate public keys and sign transactions on the crypto assets' underlying blockchain. This is called an MPC Node. All 3 computer programs are referenced in FIG. 3.

### Multi-Party Computation

Multi-party computation (MPC) is a branch of cryptography which deals with scenarios of multiple distrustful parties performing a single computation. There is a vast amount of recent research into applying MPC techniques to digital signing, with immediate applications to securing crypto assets.

MPC can be used to provide a threshold signature functionality in the following way:
1. Several parties follow a specific protocol to generate multiple independent secrets, which are never shared (and should not be).
2. These secrets are used in another protocol to produce a single digital signature.

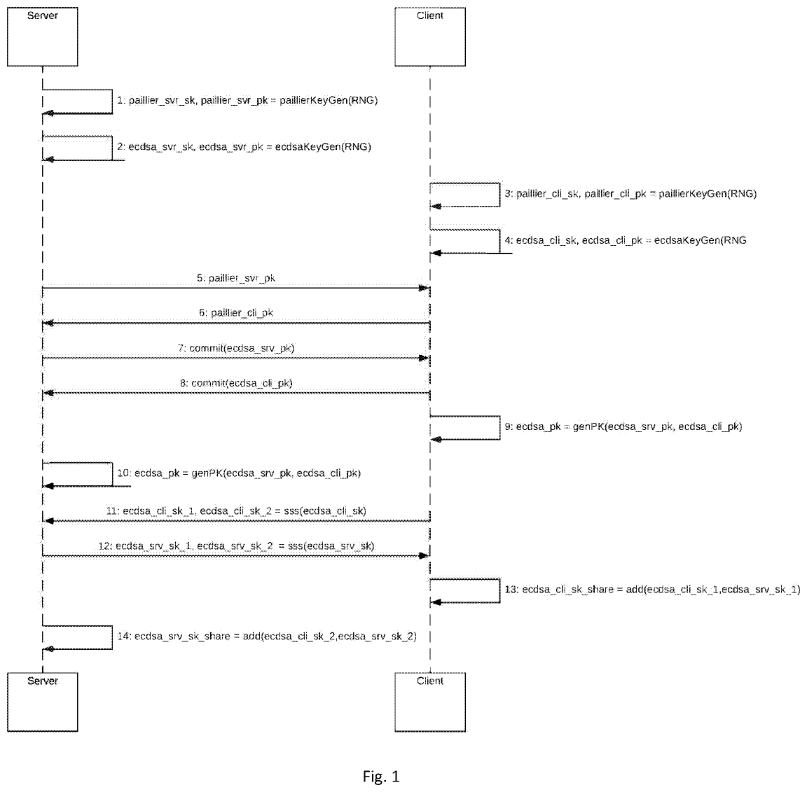

The simplest, yet arguably most useful application of MPC signing is 2-of-2 threshold scheme, where a single address is controlled by two secrets, both of which are required to produce a signature. On a first attempt to instantiate such a scheme one might envision splitting a private key into parts using the Secret Sharing Scheme, for instance) and recombining them on each signing attempt. An important distinction of MPC signing, however, is that private key is never instantiated explicitly. Public key generation happens according to FIG. 1 steps 1-9. and is sequenced as follows:

1. Both parties come up with random secrets on their own.

2. A communication channel is instantiated.

3. Both parties agree on a common public key. From this common public key, a wallet address can be created.

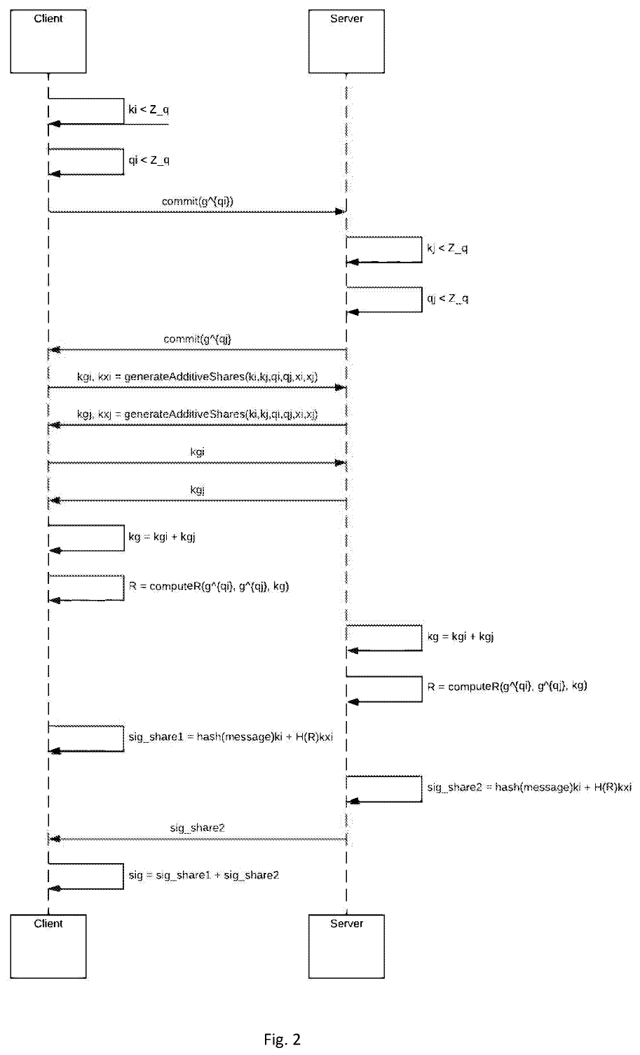

The defining feature of MPC signing, however, is that the private key never has to be reconstructed. The invention utilizes the feature that respective secrets never leave the hosts they were generated on. So in case a signature needs to be produced with a generated address, the protocol's steps from Step 10 of FIG. 1 through to the end of FIG. 2 are invoked.

The important point to note is that the secrets held by the client node are much less sensitive than a raw private key in a sense that they are not, taken has a whole, self-sufficient to reproduce a signature. In the case these secrets are compromised by an attacker, these client secrets are of no use as an attacker is unable to produce a valid signature with them.

Where the invention adds further practical benefit above and beyond the standard instantiation described above is in its ability to use its cryptographic scheme and its own blockchain to securely share the client secrets used in the MPC protocol between its users and to declare which user, running a Client Node, is able to run which portion of the MPC protocol against the MPC Node. This declaration, which the user writes into the blockchain, is what the MPC Node obeys as a list of permissions regarding who can use the client secrets of the MPC protocol to generate a signature. In this way, the MPC protocol's client secrets become even less sensitive, as they are not self-sufficient in any way to reproduce a signature. Access to the secrets, and a declaration written into the invention's blockchain, are both necessary in order to invoke the MPC protocol to obtain a signature.

Using this model, the user can grant to another user the ability to run the MPC Protocol, but only to generate a public key, which can then be used to derive the wallet address containing the crypto assets that one user wishes to trade or transfer to another user. This provides a cryptographic proof to the receiving party before a transaction occurs that enables the receiver to check the validity of the wallet address, and by extension, check what assets are contained in the wallet by querying the wallet's underlying public blockchain.

Another practical benefit of the invention is the ability to nominate other users of the invention as Trustees who approve or reject the request to share the MPC client secrets between users, and also approve or reject the request for enabling the recipient of the client secrets to run the MPC protocol to produce a signature.

### Transaction Right Ownership, Transfer and Audit

The invention employs a cryptographic scheme that exploits BLS aggregated digital signatures and aggregated public keys to create an immutable record in its blockchain declaring both the right to generate a public key (Proof of Reserves portion of the MPC protocol) and the right to generate a signature (Signature portion of the MPC protocol), creating a transaction on the underlying blockchain.

According to one aspect of the invention, all users of the invention running the Client Node computer program will generate a public/private key pair to create digital signatures with the private key and have other users verify those digital signature with their public key. The public keys are available in a public directory or even able to be written into the blockchain. A user can provide another user a reference to its public key location for use at a later point in time.

The invention makes use of the Boneh-Lynn-Shacham (BLS) digital signature scheme 1. The BLS signature scheme allows a user to verify that another user's digital signature is authentic. The scheme uses a bilinear pairing for verification, and signatures are elements of an elliptic curve group. The BLS signature scheme has special properties in that it enables signature aggregation: Multiple signatures generated under multiple public keys for multiple messages can be aggregated into a single signature, and hence the public keys can be aggregated into one public key that verifies the aggregated signature. Further, threshold signature schemes are easily constructed using the Secret Sharing scheme. A user can generate a private key, split it into a shares with a threshold (example: 2 out of 3) scheme, distribute the shares to other users, and re-assemble the signatures created from those distributed shares over the same message into an aggregated signature. This aggregated signature created from this threshold of signatures is exactly the same as a signature created by the original private key prior to being split into shares. These properties are leveraged by the invention.

Another aspect of the invention, the Client Node computer program enables a user to digitally sign messages using the BLS signature scheme and submit these messages into the invention's network for inclusion onto the invention's blockchain. Some of these messages contain aggregated signatures and/or public keys, created by the user who writes the message. The messages are checked for proper formulation by the Validator Nodes running on the invention's decentralized network. Potentially all Nodes but at a minimum the MPC and Validator Nodes will enforce a rule that no wallet ownership may be transferred to more than one user of the network if the message transferring the ownership has already been written into the blockchain or its memory pool (mempool). This works in principal the same as nodes on the bitcoin network enforcing a prohibition against double spending. The Client Node computer program is functionally able to write both BLS signatures over messages which can include aggregated signatures and aggregated public keys, but also perform the client functions of running the MPC protocol against the MPC Nodes (acting as the Server) in a 2 out of 2 threshold scheme (see FIG. 3).

Another aspect of the invention is the MPC Nodes' ability to consult the blockchain as the ultimate record of legal ownership of a wallet. This is declared as a ‘Transaction Right’ within the system of messages created within the invention that are written to its blockchain. The MPC Nodes interrogates the invention's record of wallet ownership written into its blockchain prior to running the MPC protocol with any clients to enforce the rule that only the rightful owner of the Transaction Right (i.e., wallet) is able invoke the MPC protocol run with the MPC Node and submit a cryptocurrency transaction to be signed during the MPC protocol.

### Description of a Preferred Embodiment

Setup and Wallet Creation

With reference to the drawings, a user of the invention, called a ‘ Sender’, runs the client software computer program, called a ‘Client Node’. The Client Node executes the MPC protocol to generate a public key as show in Steps 1-9 of FIG. 1. This Client Node runs the protocol against another computer program running the MPC server software (MPC Node) as shown in the overview of the communications model in FIG. 3.

The establishment of the public key is a necessary step in creating a wallet address to receive crypto assets. Most mainstream blockchains such as Bitcoin and Ethereum operate this way.

As part of securing the wallet and making it ready to fund, the Sender operating the Client Node assigns one or more users of the invention to act as ‘Trustees’ with specific responsibility to grant or deny requests for two specific operations. This aspect of the invention is called a Trustee Scheme. First, the appointed Trustee(s) can approve or deny a request to enable one or more users of the invention to run the MPC protocol using their instances of a Client Node to regenerate the public key which was used in the creation of the cryptocurrency wallet address. The ability to generate the wallet address from the first half of the MPC protocol (which necessitates and enables the generation of the public key) is called the ‘Proof of Reserves’ portion of the MPC protocol.

Second, the appointed Trustee(s) can approve or deny a request from the Sender's Client Node to transfer the right to run the MPC protocol to generate a digital signature necessary to create a transaction on a cryptocurrency network or other type of distributed ledger based network from the Sender to another user on the network, called a ‘Recipient’. The ability to sign a cryptocurrency transaction from the second half of the MPC protocol is called the ‘Signature’ portion of the MPC protocol. Note that only one other user can be the Recipient of the transfer of the right to run the full MPC protocol through the Signature portion. This enforcement negates double transfers, so the right to run the MPC protocol can only pass from one user to another user, not to multiple users. What will be illustrated is that a Sender can invoke a request to Trustees let other users of the invention to run the Proof of Reserves portion of the MPC protocol (any number), but the invention will only allow one Recipient to be the beneficiary that receives the right to run the Signature portion of the MPC protocol. This is called the Transaction Right.

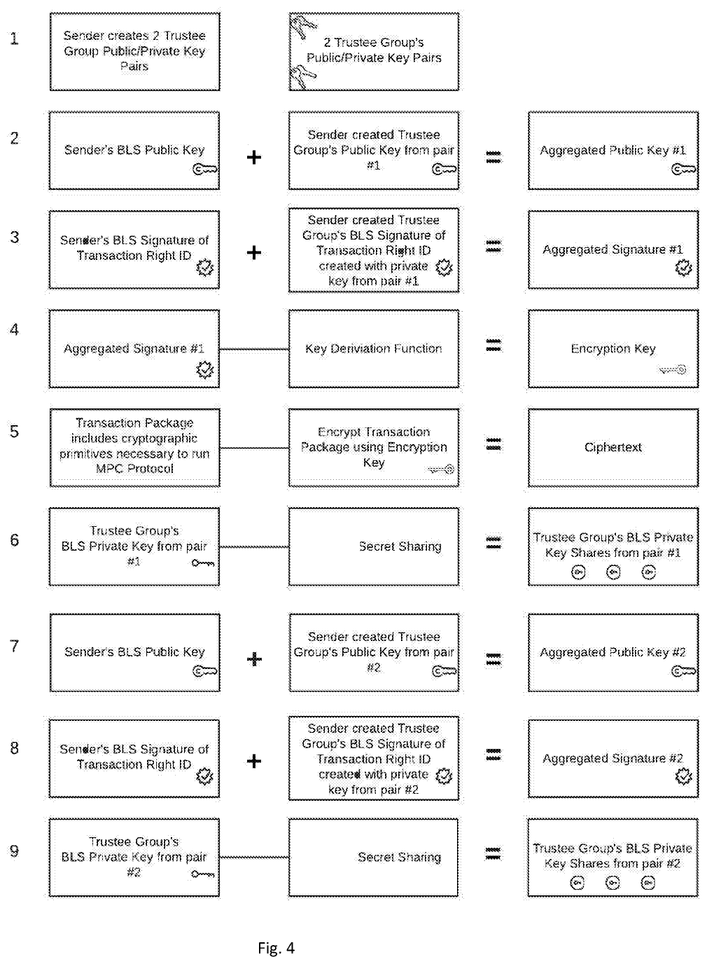

FIG. 4 shows the steps a user of the invention takes when setting up a cryptocurrency wallet using the invention. Trustees must be assigned, and cryptographic schemes must be created involving the Trustees.

As shown in Step 1 FIG. 4, the user operating a Client Node, called a “Sender” within the diagram, creates two BLS scheme public/private key pairs using the Client Node. The key pairs are used in the context of setting up Trustee schemes. The Trustee schemes requires that Trustees digitally sign messages for submission into the invention's network for inclusion into its blockchain as the immutable record of approval of either 1) enabling a potential recipient of the Transaction Right to run the MPC (multi-party computation) protocol to establish Proof of Reserves (i.e., the Proof of Reserves protocol) or 2) transferring the Transaction Right to a recipient in total. This transfer of the Transaction Right enables the recipient to run the full MPC protocol through to the final Signature portion, i.e., the Signature portion of the MPC protocol.

Step 2 of FIG. 4 illustrates that the Sender's instance of the Client Node next creates an Aggregated Public Key using the Client Node's long lived BLS public key and the public key from the first key pair created for the Trustee scheme used to grant approval for a potential recipient to run the Proof of Reserves protocol. This key pair is referred to as Trustee Group 1 in the drawings. The created Aggregated Public Key is referred to as Aggregated Public Key 1 in the drawings.

Step 3 of FIG. 4 illustrates that the Sender's instance of the Client Node next creates a digital signature of the Transaction Right ID using its long lived BLS private key. The Transaction Right ID (identifier) is a worldly unique alphanumeric string that is recognizable by all users and computer programs of the invention. The Transaction Right ID will be the identifier associated to the electronic file that contains cryptographic strings and primitives used by both Client and MPC Nodes when running an MPC protocol to generate public keys and digital signatures. This file is called a Transaction Right Package. The Client Node next creates Aggregated Signature 1 by performing the signature aggregation routine outlined in Section 2. The Aggregated Signature 1 consists of a signature created using the Sender's long-lived BLS private key aggregated with the signature created using the BLS private key from Trustee Group 1 key pair.

Step 4 of FIG. 4 illustrates the Sender's Client Node performing a key derivation function 3 using as input the Aggregated Signature 1 created in Step 3. The result from this action derives an encryption key.

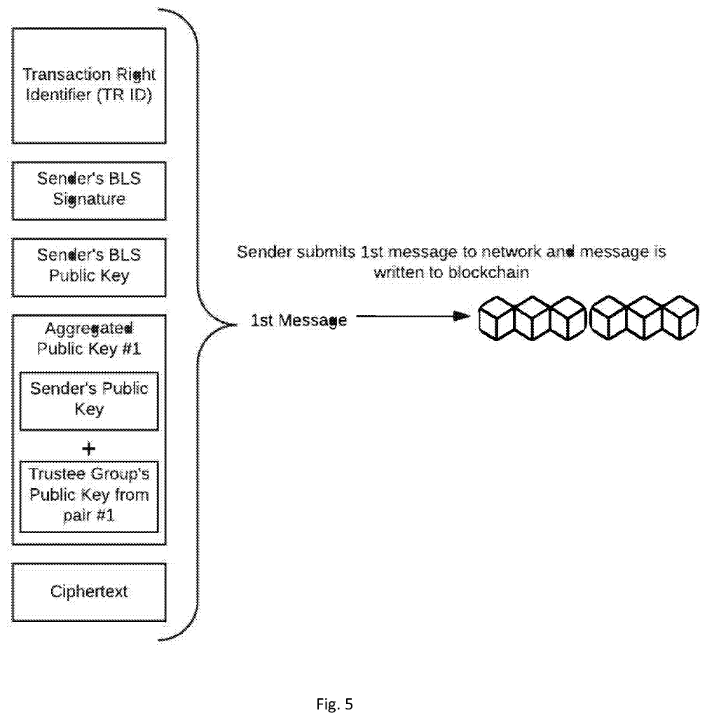

Step 5 of FIG. 4 illustrates the Sender's Client Node which takes the Transaction Right Package (a file contain cryptographic primitives and strings necessary to run the MPC protocol) and encrypting the file using the encryption key derived in the previous step to create the ciphertext as shown in FIG. 5.

Step 6 of FIG. 4 illustrates the Sender's Client Node performing the BLS Threshold Signature protocol operation from Section 2.1.2 using as input the private key from Trustee Group 1. The rest of the document refers to this threshold scheme as setup for 2 out of 3 Trustees for approval to be valid, to be used as an example (although any (t<n) scheme can be used). Hence, the private key from Trustee Group 1 is split into 3 shares, where signatures from 2 out of 3, when combined, will equate to the same signature as if it was made by Trustee Group 1 private key.

Step 7 of FIG. 4 illustrates the Sender's Client Node creating Aggregated BLS Public Key 2. The Aggregate Public Key 2 consists of the Sender's long lived BLS Public Key and the BLS public key from the Trustee Group 2 key pair. Specifically, Step 7 repeats the same processes in Step 2, but it uses Trustee Group 2 public key in the creation of Aggregated Public Key 2.

Step 8 of FIG. 4 illustrates the Sender's Client Node creating Aggregated Signature 2 from the digital signature of the Transaction Right ID using its long lived BLS private key aggregated with the signature created using the BLS private key from Trustee Group 2 key pair. Specifically, Step 8 repeats the same processes in Step 3, but it uses Trustee Group 2 private key to create one of the two digital signatures going into the Aggregated Signature 2. Step 9 of FIG. 4 illustrates the Sender's Client Node performing the same process as described in Step 6, except that it performs the operation using the private key from Trustee Group 2 to obtain 3 shares.

Once these steps are performed, the Sender's Client Node moves onto creating public and private messages to be submitted to the invention's network to be recorded on its blockchain. These messages are additional necessary steps to setup the Trustee schemes as described previously. As illustrated in FIG. 5, the first public message to be submitted to the invention's network consists of the Transaction Right ID, signed with the Sender's Client Node's long lived BLS secret key. Also included is the Sender's public key (to verify the signature) if its not already available in a directory. Also included in the message is the Aggregated Public Key 1, and the Ciphertext created from Step 5 from FIG. 4 (i.e., the encryption of the Transaction Right Package). The public messages depicted in the diagrams include additional digital signatures that are generated over the whole message body which would enable both non-repudiation and message integrity. This is simply done by generating an additional signature using the BLS long-lived private key of the message creator and affixing it to the message.

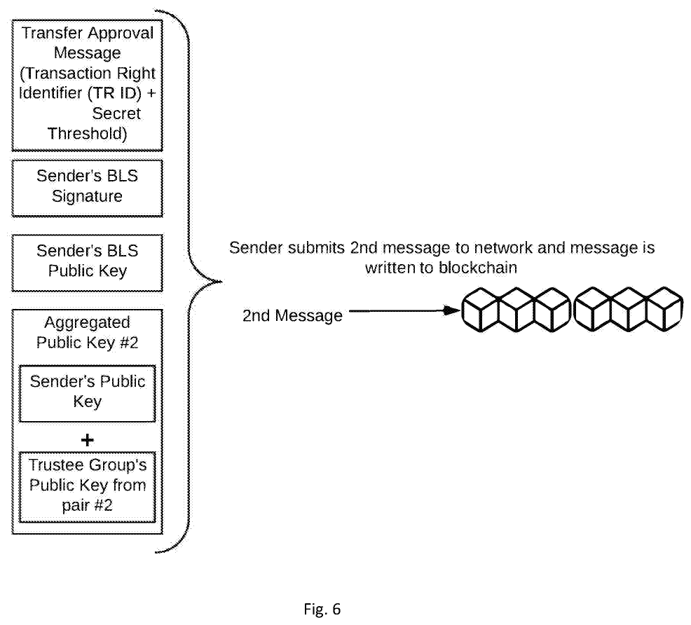

The second public message to be written into the blockchain by the Sender's Client Node is illustrated in FIG. 6. This message is constructed like the first public message, with the following exceptions: Aggregated Public Key 2 is affixed to the message vs Aggregated Public Key 1. Secondly, the plain text message incorporates the Transaction Right ID (identifier) just as the first public message does, but also includes a statement describing the number of Trustees and the Secret Sharing threshold to reconstruct the signature from the signature shares. Using our threshold of 2 out of 3 shares as an example, the statement would simply be “2/3” or some other variant. The encoding and actual specifics of the statement are not consequential to the invention as long as the information is conveyed.

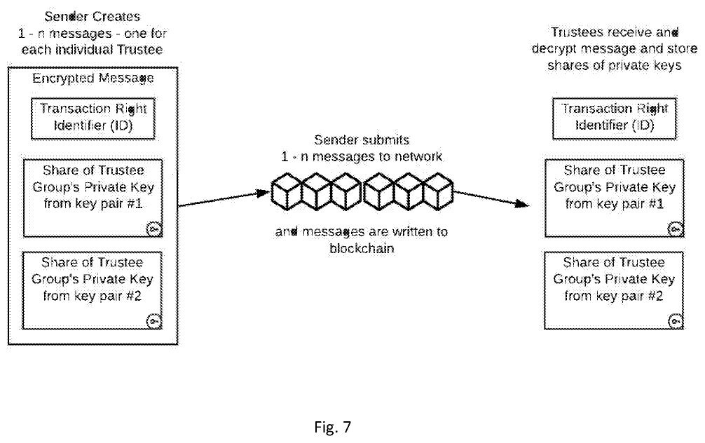

The Sender's Client Node moves onto creating a third message, which is a private message. The privacy is enforced by encrypting it uniquely for each individual Trustee. In a general sense, public/private key cryptography 4 can be utilized to provide this security. Specifying an exact implementation is not necessary for the invention's efficacy as long as the flavour of and implementation is secure. The form and content of this message is outlined in FIG. 7. Each encrypted message to a Trustee contains within its ciphertext the Transaction Right ID, and one Secret Share protocol generated share of the private key from Trustee Group 1 key pair, and one from Trustee Group 2 key pair. Upon receipt, the Trustee decrypts the message and stores the shares of the private keys. The Trustee would send a message back to the Sender acknowledging receipt of the message and acceptance of its governance role over the wallet.

Once these Trustee schemes are in place, the Sender's Client Node will make the wallet address known to the Sender as being ready to fund.

### Proof of Reserves

A common problem that professional traders of cryptocurrencies experience is to be able to prove to another counter-party that they have control of a particular wallet address, and hence they have the ability to deliver these assets to the counter-party to instantiate a trade or sale of these assets. The most common method of solving this problem is to access the wallet's private key, create a digital signature using the private key which can be verified by the public key used to create the wallet address. Accessing the private key for this operation can introduce costs and create security risks for the wallet owner.

The invention solves this issue by enabling a user of the invention using their Client Node the ability to generate the public key that was used in the creation of the wallet without accessing the private key. The sequence of messages that ultimately lead to the counter-party being able to generate the public key used in the creation of the wallet address establishes proof that the user known as the Sender has possession of the assets. A further sequence of steps enables the counter-party, who is also running a Client Node, to actively monitor the invention's blockchain in order to ascertain that the Transaction Right is still held by the Sender. This counter-party will be henceforth referred to as a Potential Recipient of the Transaction Right.

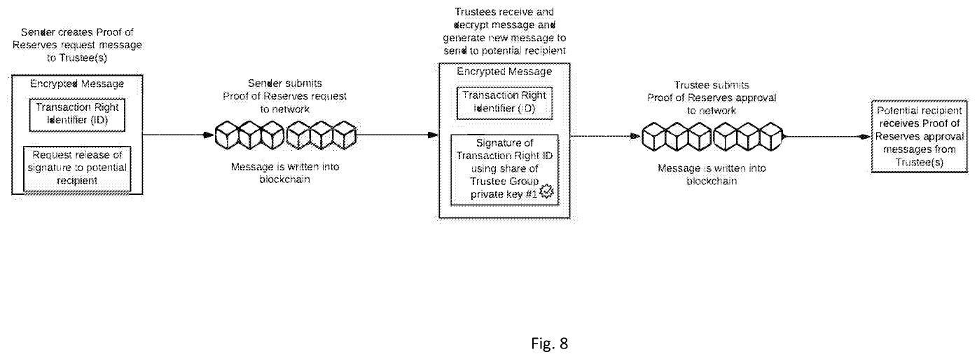

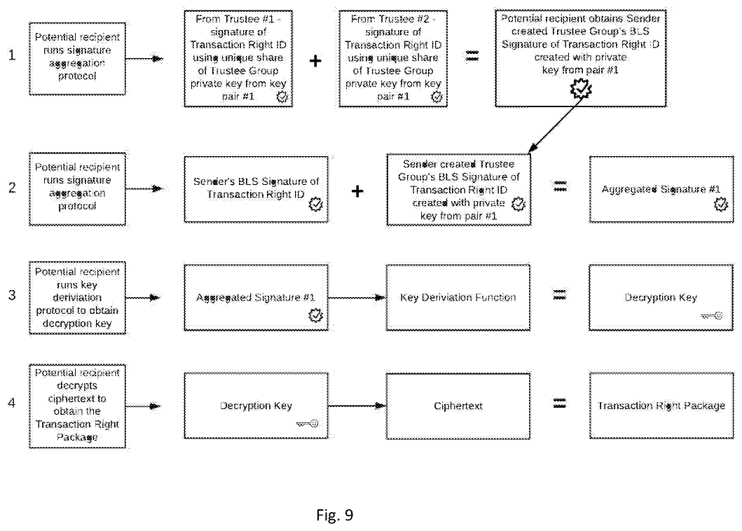

The Sender initiates the sequence of steps through their Client Node, starting with the sequence of messages illustrated in FIG. 8. First, the Sender creates a private, encrypted message to each individual Trustee received a share of the private key from Trustee Group 1 key pair. This message is called a Proof of Reserves request message. Included within the message is the Transaction Right ID, and some message that establishes the request that the Trustee digitally sign the Transaction Right ID with the share of the private key from Trustee Group 1 key pair. Each Trustee will receive the message, decrypt the message and process the request using their Client Nodes. Assuming the Trustee consents to the request, the Trustee creates its own message to send to the Potential Recipient. The message it creates for the Potential Recipient is also private, encrypted uniquely for the Potential Recipient. Included within the message is the digital signature of the Transaction Right ID created by the Trustee using the share of the private key from Trustee Group 1 key pair as a BLS private key (used to create BLS scheme digital signatures). The Potential Recipient receives encrypted messages from Trustees containing the part signatures. Herein, if the threshold of Trustees approves and by extension sends the Proof of Reserves approval messages to a Potential Recipient, then the Potential Recipient is able to rebuild the Aggregated Signature 1 using its Client Node computer program. From this signature, it can then perform the key derivation function, obtain a decryption key for the Transaction Right Package, and run the Proof of Reserves protocol. This sequence of steps is illustrated in FIG. 9. Within this sequence of steps are the background messages from Sender to Potential Recipient. These messages would, for example, alert the Potential Recipient as to how many part signatures it needs to receive from Trustees before it begins the signature aggregation protocol, the Transaction Right ID and other pertinent information.

Beginning with Step 1 of FIG. 9, the Potential Recipient (using its Client Node computer program) runs the threshold signature aggregation protocol from Section 2.1.2 to rebuild the signature of the Transaction Right ID from the part signatures received from the Trustees. This completed signature is equal to the signature which would have been created by the complete/whole private key from Trustee Group 1 key pair.

In Step 2 of FIG. 9, the Potential Recipient obtains the digital signature of the Transaction Right ID created by the Sender's BLS private key. It obtains this signature directly from the first public message created by the Sender which is now written into the invention's blockchain. By combining this publicly available signature (Sender's BLS scheme signature of the Transaction Right ID) with the privately obtained (secret) threshold aggregated completed signature (Trustee Group's BLS Signature of the Transaction Right ID created using the private key from Trustee Group 1 key pair), it can create the Aggregated Signature 1 used to derive the encryption/decryption key of the Transaction Package.

In Step 3 of FIG. 9, the Potential Recipient obtains the Decryption Key for the Transaction Right package (ciphertext from FIG. 5) by key derivation function. In Step 4 of FIG. 9, the Potential Recipient decrypts the Transaction Right Package. Using this information, the Potential Recipient's Client Node is now able to run the Proof of Reserves portion of the MPC Protocol against the MPC Node in the decentralized network as shown in Steps 1-9 in FIG. 1. By executing these steps, the Potential Recipient obtains the public key which can be utilized to obtain the wallet address in question.

There are ancillary steps the Client Node can undertake to proactively watch the wallet address by connecting to a service that can provide information on the activity of the invention's blockchain in regards to that specific Transaction Right. Stated another way, the Potential Recipient can instruct its Client Node to alert it to any Transfer Messages that are submitted to the network to be processed by the Validator Nodes.

### Transfer of Transaction Right

The invention enables the transfer of the Transaction Right between users. The following example describes the transfer whereby Trustees were assigned governance responsibility over approving the transfer of the Transaction Right between users as previously described and illustrated in FIGS. 4-7.

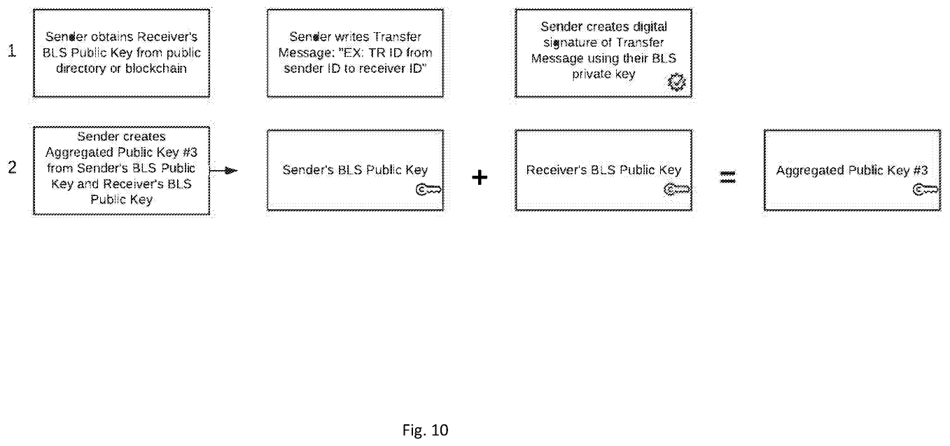

To begin, a Sender instructs its Client Node computer program to create a Transfer Message as illustrated in FIG. 10. Each Client Node has a worldly unique identifier called an Account Code when it initializes and connects onto the invention's network. The Transfer Message is simply a machine readable message that states a Transaction Right ID is being transferred from the Sender's Client Node (as referenced by their Account Code) to the Recipient's Client Node (as referenced by their Account Code). An example, in human readable form, would be:

### Transaction Right ID

### FROM: Account Code (of Sender/Party A)

### TO: Account Code (of Recipient/Party B)

As illustrated in Step 1 of FIG. 10, the Sender's Client Node next creates a digital signature of the above Transfer Message using their long-lived BLS private key. Next, as shown in Step 2, the Sender's Client Node creates Aggregated Public Key 3 from the combination of the Sender's login-lived BLS public key and the Recipient's long-lived BLS public key. As stated previously, both parties should be able to obtain their counter-party's long lived BLS public keys from a directory or other mechanism, or directly from an entry on the blockchain. The exact mechanism of how counterparties obtain long-lived BLS public keys is not important to the operation of the invention as long as the mechanism is secure.

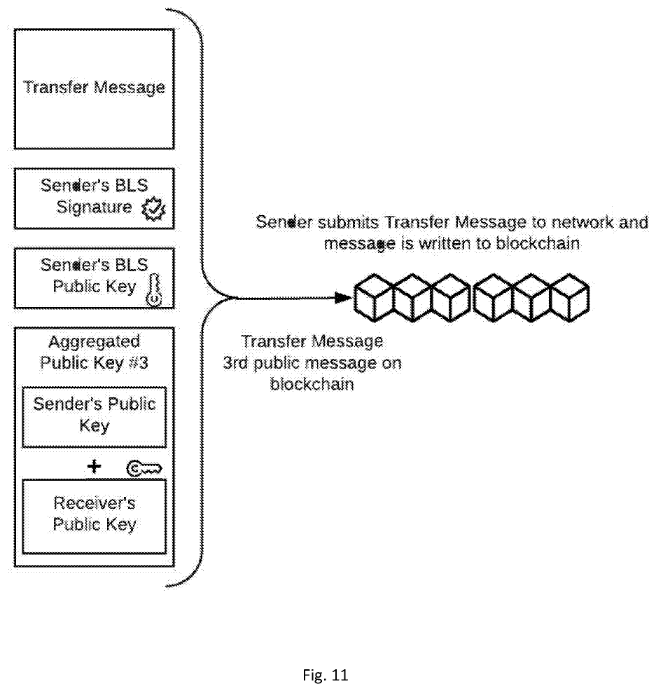

The next step has the Sender's Client Node submit the complete Transfer Message into the invention's network to be written into its blockchain. The construction of the Transfer Message is shown in FIG. 11. Included in the entirety of the message is the Transfer Message, the Sender's signature over the message, the public key to verify the signature over the message, and the Aggregated Public Key 3.

Not shown in the illustrations are other ancillary messages sent from the Sender to the Recipient. As an example, the Sender will notify the Recipient that the Transfer Message has been submitted to the network, and may include a pointer to the message locator within the blockchain so the Recipient can perform its next sequential step.

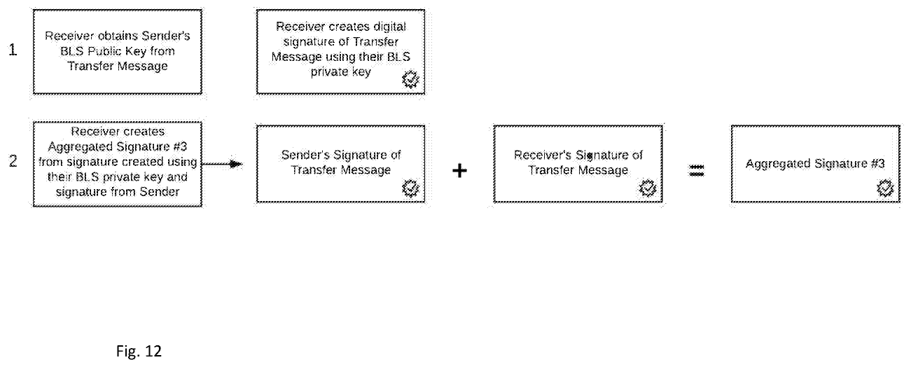

Once the Recipient has obtained the message from FIG. 11, it performs two steps as illustrated in FIG. 12. First, it verifies the signature of the Sender using the Sender's long-lived BLS public key. As shown in Step 1 of FIG. 12, the Recipient should obtain the Sender's public key from a directory or other mechanism as stated in previous descriptions. Next, as shown in Step 2 of FIG. 12, the Recipient creates a Aggregated Signature 3. It does this by taking a copy of the plaintext of the Transfer Message sent by the Sender (FIG. 11) and creates a signature of the plaintext using its long-lived BLS private key. The Recipient then takes a copy of the digital signature created by the Sender on the Transfer Message (again from FIG. 11) and creates the Aggregated Signature 3 using the Sender's signature and it's just created signature of the Transfer Message. The Recipient is now in possession of both Aggregated Signature 3, and Aggregated Public Key 3 (from FIG. 11).

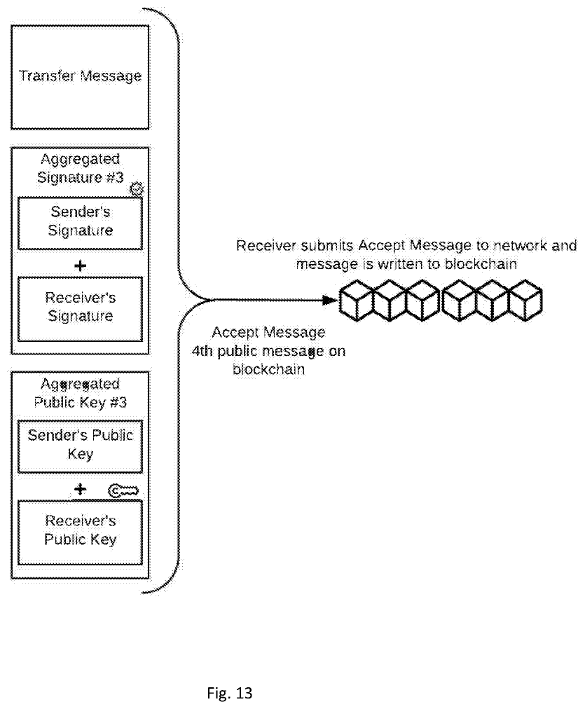

Finally, the Recipient creates its own Accept Message to signify to other users and Nodes on the invention's network/blockchain that it has ‘accepted’ the transfer of the Transaction Right. As shown in FIG. 13, the Recipient constructs an Accept Message by reusing the Transfer Message from FIG. 11 and affixing both the Aggregated Signature 3 and Aggregated Public Key 3 to the Transfer Message.

This signifies acceptance of the transfer of the Transaction Right by the Recipient because only the Recipient's Client Node could have created an Aggregated Signature (from FIG. 13) that verifies with the Aggregated Public Key created by Sender's Client Node (first shown in FIG. 11). The invention exploits the property of BLS signature scheme in that a BLS public key can be aggregated together from other known BLS public keys prior to an aggregated BLS signature being put together from other signatures that have not even been generated yet. It is this ability to create a public key from multiple public keys that will verify a signature, put together from multiple signatures created by different, multiple parties at a future date that enables all Nodes on the network to validate conditions such as the acceptance of a transfer of a Transaction Right from a Sender to a future Recipient and the approval of a transfer of a Transaction Right request generated by a Sender to be issued by a collection of Trustees.

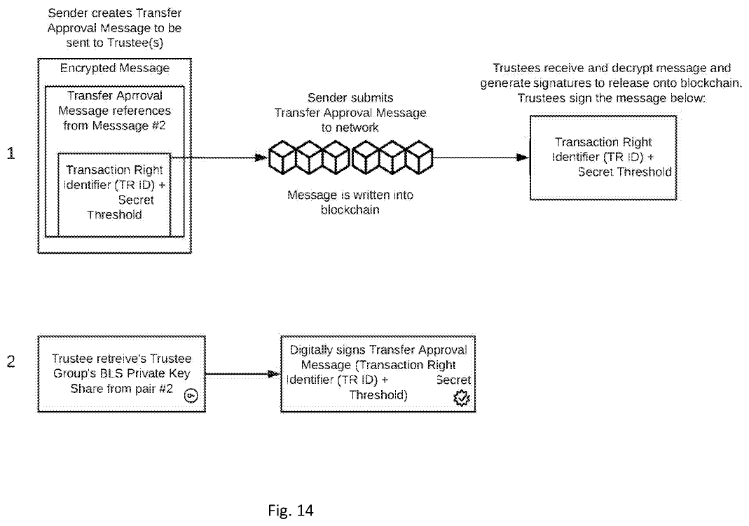

While the transfer of the Transaction Right originated by the Sender has been approved between the Sender and the Recipient, it has not yet been approved by the Trustees assigned with governance responsibility to approve or deny the transfer of the Transaction Right. The sender begins this process by creating a message to send to each individual Trustee assigned to the wallet using their Client Node. This is a private, encrypted message. The Sender's Client Node copies the plaintext of the Transfer Approval message from the second public message as shown in FIG. 6 and sends this in an encrypted message to the Trustee as illustrated in Step 1 of FIG. 14. The original Transfer Message serves as a reference for the Trustee to lookup the Transaction Right on the blockchain (as it contains the Transaction Right ID) and to obtain the share of the private key from Trustee Group 2 key pair that it has stored, as well as being the message to be signed by the Trustee. As illustrated in Step 2 of FIG. 14, the Trustee's Client Node retrieves the share of the private key created from Trustee Group 2 BLS private key that it has previously received, and using this key share as a private key itself, it creates a digital signature of the Transfer Approval Message.

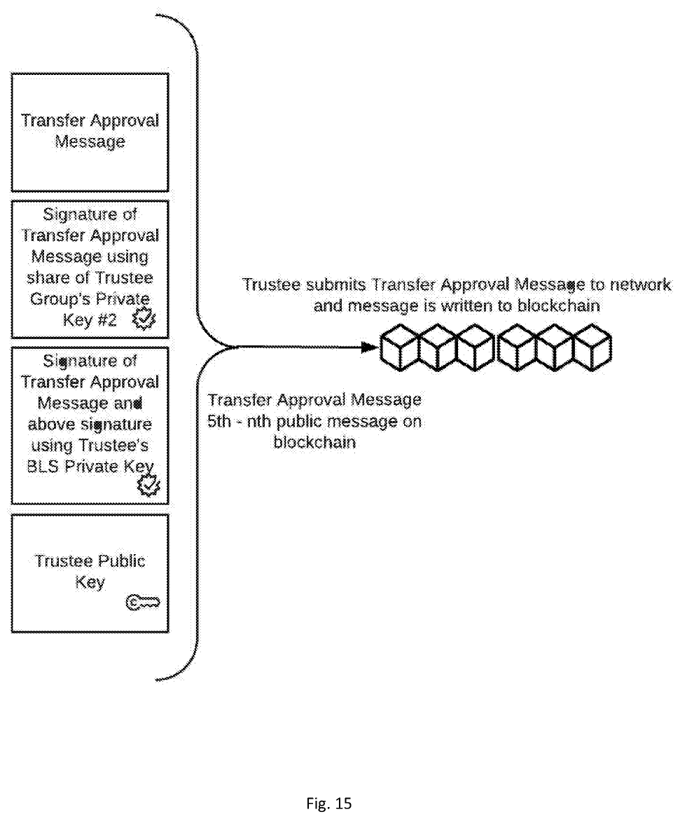

Finally, the Trustee's Client Node assembles the public Transfer Approval Message to submit to the network for inclusion into the invention's blockchain. As illustrated in FIG. 15, the public message is the concatenation of the Transfer Approval Message (containing the Transaction Right ID and the Secret Sharing threshold scheme description) and the signature that the Trustee has created using the share of the private key from Trustee Group 2 key pair. Additionally, the Trustee's Client Node digitally signs the concatenation of the two items just described with its long-lived BLS private key, and the affixes that signature its public key (to verify the signature) to complete the whole public message. The Trustee's Client Node then submits this completed signature (as shown in FIG. 15) to the invention's network. Note that this process must occur once for each Trustee that has been assigned with responsibility to approve (or reject) the request to transfer the Transaction Right from one user of the invention to another user. As in the example the Secret Sharing threshold of 2 out of 3 that was previously described, at least 2 out of the 3 Trustees must submit these public messages into the invention's network/blockchain in order for a Validator Node, and ultimately and MPC Node, to recognize the transfer as a valid transaction on the network.

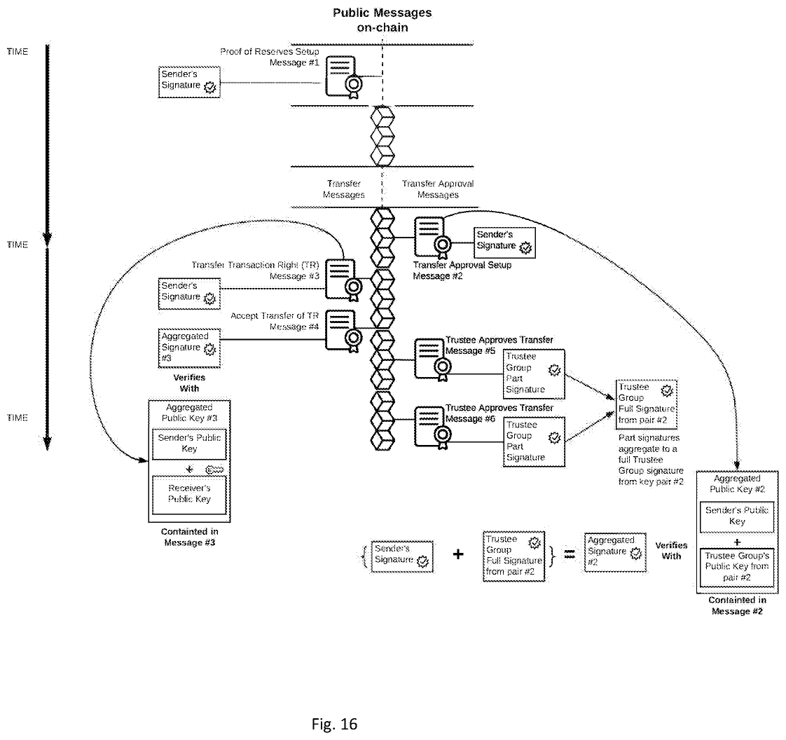

The illustration in FIG. 16 shows a higher level view of all the messages on the blockchain working together to achieve this objective. Beginning at the top of the diagram, the Sender starts with the Proof of Reserves setup message “Public Message 1”. Note the subsequent messages that request the release of part signatures from Sender to Trustee's in order for a Potential Recipient to decrypt the Transaction Package as described previously are private, encrypted messages and for the sake of brevity are not shown on this illustration.

Public Message 2 is the Transfer Approval Setup Message created by the Sender and which contains the Aggregated Public Key 2. This locks into place on the blockchain the required threshold of assigned Trustees who will have to write into the blockchain messages which enable the Validator and MPC Nodes to rebuild the Aggregated Signature which can be verified using the Aggregated Public Key 2 which was included in this message. For these future messages to be accepted as valid by the Validator and MPC nodes, they can only occur AFTER the Transfer of Transaction Right messages between Sender and Recipient are included into the blockchain (Public Messages 3 and 4).

Going forward from to bottom, we see the next public message is the Transfer Message (Public Message 3) in which the Sender creates the Aggregated Public Key 3 which is the combination of the Sender's public key and the Recipient's public key. Using the same principal as locking in the Trustees on the Transfer Approval Setup Message, in a future message, an aggregated signature must be submitted to the blockchain which must be able to be verified by Aggregated Public Key 3 included in the Public Message 3. The same principal applies as Trustees on the Transfer Approval Setup Message: Only the Recipient can create an Aggregated Signature 3 that will verify with the Aggregated Public Key 3 as only the Recipient possesses the private key necessary to create a signature and combine that signature with the signature created by the Sender which exists in Public Message 3. This is illustrated on the left hand side of the illustration of FIG. 16 as Aggregated Signature 3 from Public Message 4 “VERIFIES WITH” Aggregated Public Key 3 which was inside of Public Message 3.

Once both Sender and Recipient have completed the Transfer of the Transaction Right, the Sender sends private, encrypted messages to the Trustees as previously described (but not shown on FIG. 16) that request the approval of the Transfer of the Transaction Right. The sender locked in the specific Trustees and the threshold of required Trustees when the Sender created the Public Message 2 as illustrated on the right hand side of FIG. 16 under the “Transfer Approval Messages” column. Inside of the Transfer Approval Setup Message is the Aggregated Public Key 2. In the example used within the document, the Sender created a Secret Sharing scheme on the BLS private key from Trustee Group 2 key pair so 2 out of 3 required Trustees must sign the Transfer Approval Message and submit those messages for inclusion into the invention's network/blockchain as shown in Public Messages 5 and 6 in FIG. 16. As shown in the illustration, the part signatures that exist within these two messages are aggregated by the Validator and/or MPC Nodes to create an aggregated signature called Trustee Group Full Signature, which is exactly the same signature that would have been created by the private key from Trustee Group 2 key pair if it was used to sign the Transfer Approval Message. The Nodes can validate that the correct Trustees and threshold have approved the Transfer of Transaction Right by assembling Aggregated Signature 2 from the Trustee Group Full Signature combined with the Sender's signature that was inside of the Sender's Public Message 2. If the Aggregated Public Key 2, which was also included in Public Message 2, validates the Aggregated Signature 2, then the correct Trustees and threshold of Trustees have approved the transfer.

The software code inside of the MPC Node is programmed to respect the verification of the signatures and enforce rules that result from these signature verifications, or the lack thereof. Most obviously, the MPC Node would not accept the request to invoke and run the MPC Protocol through to the final Signature portion of the protocol unless the Client Node invoking the MPC protocol was verified as being the owner of the Transaction Right. Logically, Nodes would also prohibit the transfer of a Transaction Right unless it was the rightful owner initiating the transfer.

### Atomic Swaps

Enabling complex atomic swaps is simple; the Sender merely needs to write in the message the transfer of an additional Transaction Right from the other counter-party. Example:

### Transaction Right ID

### FROM: Account Code (of Sender/Party A)

### TO: Account Code (of Recipient/Party B)

+

### Transaction Right ID

### FROM: Account Code (of Recipient/Party B) TO: Account Code (of Sender/Party A)

This kind of swap of crypto assets necessitates that both counterparties initiate to their Trustees the request for approval of the Transfers, but in all other respects the processes outlined previously apply.

### MPC Node Threshold Decryption

MPC Nodes that validate and verify the ownership of a Transaction Right can join together to decrypt the corresponding Transaction Right Packages that they encrypt and secure on the invention's blockchain by way of a threshold decryption protocol as described above. In this way, they have their own secured mechanism of accessing and securing Transaction Right Packages that are under the MPC Nodes' exclusive control. By implementing a Threshold Decryption mechanism, a majority threshold of MPC Nodes in operation must validate the transfers and ownership of Transaction Rights in tandem before the Transaction Right Packages that are exclusively accessed by the MPC Nodes can be decrypted. This helps to secure those Transaction Right Packages against a minority of dishonest MPC Nodes.

### Operating Environment:

The system is typically comprised of a central server that is connected by a data network to a user's computer. For example, the Qredo custody node may operate on a server or combination of servers. The principal may be an application running on a first person's personal device, and the application's execution operates the processes that conducts the transfer of the digital asset by interacting with the Qredo server. The beneficiary may be an application running on a second person's mobile device that interacts with the Qredo server as well. The IPFS may be a distributed storage system also serviced using servers that may be accessed by either the principal or beneficiary's applications by addressing across the digital network. In addition, in the Bitcoin context, Bitcoin validation servers may also be accessed by the two applications in order to verify the transaction. Further, there may be a set of servers that are connected to the network that act as a distributed ledger, including as an example, the blockchain. The central server may be comprised of one or more computers connected to one or more mass storage devices. The precise architecture of the central server does not limit the claimed invention. In addition, the data network may operate with several levels, such that the user's computer is connected through a fire wall to one server, which routes communications to another server that executes the disclosed methods. The precise details of the data network architecture does not limit the claimed invention. Further, the user's computer platform device may be a laptop or desktop type of personal computer. It can also be a cell phone, smart phone or other handheld device. The precise form factor of the user's computer platform device does not limit the claimed invention. Further, the customer may receive from and transmit data to the central server by means of the Internet, whereby the customer accesses an account using an Internet web-browser and browser displays an interactive web page operatively connected to the central server. The central server transmits and receives data in response to data and commands transmitted from the browser in response to the customer's actuation of the browser user interface. The program can detect the relative location of the cursor when the mouse button is actuated, and interpret a command to be executed based on location on the indicated relative location on the display when the button was pressed. Similarly, the program can detect the location of a touch on the screen. The data file may be an HTML document, the program a web-browser program and the command a hyper-link that causes the browser to request a new HTML document from another remote data network address location. The data file may also contain scripts, which are computer program commands, which are executed by the browser. The data file may also contain references to objects stored either locally or remotely that the browser may then access and display or otherwise render. The browser can thereby fetch additional data that is stored on a remote server accessed using the Internet.

The Internet is a computer network that permits customers operating a personal computer to interact with computer servers located remotely and to view content that is delivered from the servers to the personal computer as data files over the network. In one kind of protocol, the servers present webpages that are rendered on the user's computer platform using a local program known as a browser. The browser receives one or more data files from the server that are displayed on the customer's personal computer screen. The browser seeks those data files from a specific address, which is represented by an alphanumeric string called a Universal Resource Locator (URL). However, the webpage may contain components that are downloaded from a variety of URL's or IP addresses. A website is a collection of related URL's, typically all sharing the same root address or under the control of some entity.

A server may be a computer comprised of a central processing unit with a mass storage device and a network connection. In addition a server can include multiple of such computers connected together with a data network or other data transfer connection, or, multiple computers on a network with network accessed storage, in a manner that provides such functionality as a group. Practitioners of ordinary skill will recognize that functions that are accomplished on one server may be partitioned and accomplished on multiple servers that are operatively connected by a computer network by means of appropriate inter process communication. In addition, the access of the website can be by means of an Internet browser accessing a secure or public page or by means of a client program running on a local computer that is connected over a computer network to the server. A data message and data upload or download can be delivered over the Internet using typical protocols, including TCP/IP, HTTP, SMTP, RPC, FTP or other kinds of data communication protocols that permit processes running on two remote computers to exchange information by means of digital network communication. As a result a data message can be a data packet transmitted from or received by a computer containing a destination network address, a destination process or application identifier, and data values that can be parsed at the destination computer located at the destination network address by the destination application in order that the relevant data values are extracted and used by the destination application.

It should be noted that the flow diagrams are used herein to demonstrate various aspects of the invention, and should not be construed to limit the present invention to any particular logic flow or logic implementation except as expressly claimed. The described logic may be partitioned into different logic blocks (e.g., programs, modules, functions, or subroutines) without changing the overall results or otherwise departing from the true scope of the invention. Oftentimes, logic elements may be added, modified, omitted, performed in a different order, or implemented using different logic constructs (e.g., logic gates, looping primitives, conditional logic, and other logic constructs) without changing the overall results or otherwise departing from the true scope of the invention. The logic described herein may be expressed by computer code that is performed by the computers comprising the system when that code is executed by the computer system. For example, where the disclosure recites a determination or validation whether a condition exists, this may be accomplished by the computer code including a conditional branching statement using a Boolean logical condition, and then that statement resulting in alternative process steps being executed based on the data representation of the condition being determined or validated. In other embodiments, where the disclosure recites a determination, it may be that the computer executes program steps that run a calculation using data representing input state conditions in order to calculate data as a result that represents such a determined result. Similarly, when the invention is described as executing a selection, that may be by the computer system executing code that repeatedly loops on a Boolean logical condition of matching one data value against a set of other data values until a matching data value is found. Some of the logic may be expressed in hardware at a lower level of operation, and that hardware logic utilized by the program logic to provide more complex logical functions. All of these components may be adapted into modules that result in the computer system executing the process that the logic represents.

The method described herein can be executed on a computer system, generally comprised of a central processing unit (CPU) that is operatively connected to a memory device, data input and output circuitry (JO) and computer data network communication circuitry. Computer code executed by the CPU can take data received by the data communication circuitry and store it in the memory device. In addition, the CPU can take data from the I/O circuitry and store it in the memory device. Further, the CPU can take data from a memory device and output it through the IO circuitry or the data communication circuitry. The data stored in memory may be further recalled from the memory device, further processed or modified by the CPU in the manner described herein and restored in the same memory device or a different memory device operatively connected to the CPU including by means of the data network circuitry. The memory device can be any kind of data storage circuit or magnetic storage or optical device, including a hard disk, optical disk or solid state memory. The CPU may perform logic comparisons of one or more of the data items stored in memory or in the cache memory of the CPU, or perform arithmetic operations on the data in order to make selections or determinations using such logical tests or arithmetic operations. The process flow may be altered as a result of such logical tests or arithmetic operations so as to select or determine the next step of a process. The CPU may change an addressing pointer for the next instruction to execute based on the result of such a logical test and thereby perform the change in process flow dependent on the determined logical state.

Examples of well known computing platforms, systems, environments, and/or configurations that may be suitable for use with the invention include, but are not limited to, personal computers, server computers, hand-held, laptop, tablet or mobile computer or communications devices such as cell phones, smart phones and PDA's, multiprocessor systems, microprocessor-based systems, set top boxes, programmable consumer electronics, network PCs, minicomputers, mainframe computers, distributed computing environments that include any of the above systems or devices, and the like. These may operate using as an operating system Windows, iOS, OSX, Android, Linux, Unix, Symbian and Blackberry including the various versions and variants thereof.

Computer program logic implementing all or part of the functionality previously described herein may be embodied in various forms, including, but in no way limited to, a source code form, a computer executable form, and various intermediate forms (e.g., forms generated by an assembler, compiler, linker, or locator.) Source code may include a series of computer program instructions implemented in any of various programming languages (e.g., a scripting language, like JAVA, Java Script, an assembly language, or a high-level language such as FORTRAN, C, C++). The source code may be compiled before execution and distributed as object code that is executed on the target computer or compiled as it is executed by the target computer, in each case for use with various operating systems or operating environments. The source code may define and use various data structures and communication messages. The source code may be in a computer executable form (e.g., via an interpreter), or the source code may be converted (e.g., via a translator, assembler, or compiler) into a computer executable form. The steps of

The invention may be described in the general context of computer-executable instructions, such as program modules, being executed by a computer. Generally, program modules include routines, programs, objects, components, data structures, etc., that perform particular tasks or implement particular abstract data types. The computer program and data may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed hard disk), an optical memory device (e.g., a CD-ROM or DVD), a PC card (e.g., PCMCIA card), or other memory device. The computer program and data may be fixed in any form in a signal that is transmittable to a computer using any of various communication technologies, including, but in no way limited to, analog technologies, digital technologies, optical technologies, wireless technologies, networking technologies, and internetworking technologies. The computer program and data may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.)

The invention may also be practiced in distributed computing environments where tasks are performed by remote processing devices that are linked through a communications network. In a distributed computing environment, program modules may be located in both local and remote computer storage media including memory storage devices. Practitioners of ordinary skill will recognize that the invention may be executed on one or more computer processors that are linked using a data network, including, for example, the Internet. In another embodiment, different steps of the process can be executed by one or more computers and storage devices geographically separated by connected by a data network in a manner so that they operate together to execute the process steps. In one embodiment, a user's computer can run an application that causes the user's computer to transmit a stream of one or more data packets across a data network to a second computer, referred to here as a server. The server, in turn, may be connected to one or more mass data storage devices where the database is stored. The server can execute a program that receives the transmitted packet and interpret the transmitted data packets in order to extract database query information. The server can then execute the remaining steps of the invention by means of accessing the mass storage devices to derive the desired result of the query. Alternatively, the server can transmit the query information to another computer that is connected to the mass storage devices, and that computer can execute the invention to derive the desired result. The result can then be transmitted back to the user's computer by means of another stream of one or more data packets appropriately addressed to the user's computer.

The described embodiments of the invention are intended to be exemplary and numerous variations and modifications will be apparent to those skilled in the art. All such variations and modifications are intended to be within the scope of the present invention as defined in the appended claims. Although the present invention has been described and illustrated in detail, it is to be clearly understood that the same is by way of illustration and example only, and is not to be taken by way of limitation. It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination. It is appreciated that the particular embodiment described in the Appendices is intended only to provide an extremely detailed disclosure of the present invention and is not intended to be limiting. It is appreciated that any of the software components of the present invention may, if desired, be implemented in ROM (read-only memory) form. The software components may, generally, be implemented in hardware, if desired, using conventional techniques.

The foregoing description discloses only exemplary embodiments of the invention. Modifications of the above disclosed apparatus and methods which fall within the scope of the invention will be readily apparent to those of ordinary skill in the art. Accordingly, while the present invention has been disclosed in connection with exemplary embodiments thereof, it should be understood that other embodiments may fall within the spirit and scope of the invention, as defined by the following claims.

1. A computer system for securing a digital crypto asset data object using a cryptographic registry comprising:
A plurality of client nodes;
At least one validator nodes; and
At least one MPC node comprised of a computer comprised of computer code stored in a computer memory that when executed causes the computer to operate a multi-party computational protocol (MPC), said client nodes, at least one validator nodes, the MPC nodes and the cryptographic registry being operatively connected over a digital data network.

2. The system of claim 1 where the computer code stored in the computer memory of the MPC node further causes the MPC node to generate at least one public key and sign at least one transaction on the cryptographic registry.

3. The system of claim 1 where the MPC node participates in a threshold decryption scheme.

4. The system of claim 3 where the client nodes operatively connected to the MPC node participate in the threshold decryption scheme.

5. The system of claim 1 where the cryptographic registry is comprised of stored data representing a reference to the digital crypto asset data object.

6. The system of claim 1 where the client nodes are comprised of a computer memory comprised of program code that when executed causes the client nodes to digitally sign messages using the BLS signature scheme and store these messages in the cryptographic registry.

7. The system of claim 1 where either the client nodes, validation nodes or MPC nodes are comprised of a computer memory comprised of program code that when executed causes the respective client nodes, validation nodes or MPC nodes to enforce a logical rule that a message data object representing a transfer of a wallet ownership will not be validated if a logical condition exists that a message transferring the wallet ownership has already been written into the cryptographic registry or a memory pool (mempool).

8. The system of claim 1 where at least one client node is comprised of computer memory storing at least one data secret and a computer memory comprised of program code that when executed causes the client node to generate a declaration data object and write the data object into the cryptographic registry, said declaration data object comprised of data representing a list of at least one permission values corresponding to an at least one user who is permitted to use the client node data secret with a computer operating the MPC protocol to generate a digital signature,

9. The system of claim 8 where the MPC node is comprised of computer code that when executed causes the MPC node to obey the at least one permission values.

10. The system of claim 9 where the MPC node is comprised of computer code that when executed causes the MPC node to condition the generation of the digital signature on the logical condition that the user has access to the client node data secret and that a corresponding permission value is present in the cryptographic registry.

11. The system of claim 9 where the MPC node is comprised of computer code that when executed causes the MPC node to permit a first user grant to a second user permission to run the MPC protocol to generate a public key, and use the generated public key to derive a wallet address comprised of an at least one crypto asset of the first user, but not generate any key that transfers ownership of the wallet or the crypto asset from the first user.

12. The system of claim 1 where either the client nodes, validation nodes or MPC nodes are comprised of a computer memory comprised of program code that when executed causes the respective client nodes, validation nodes or MPC nodes to receive from a first user a message representing the designation of a second user as a trustee and to receive from the trustee a data message representing the approval or rejection of a request message to share an MPC client secret of the first user with a second user.

13. The system of claim 12 where either the client nodes, validation nodes or MPC nodes are comprised of a computer memory comprised of program code that when executed causes the respective client nodes, validation nodes or MPC nodes to receive from a first user a message representing the designation of a second user as a trustee and to receive from the trustee a data message representing the approval or rejection of a request message to enable the second user to run the MPC protocol to produce a signature.

14. The system of claim 1 where the client nodes, the validation nodes and the MPC nodes are comprised of computer memory containing program code that when executed causes the system to operate a cryptographic scheme using BLS aggregated digital signatures and aggregated public keys to generate and store on the cryptographic registry at least one data record representing the declaration of right to generate a public key corresponding to the proof of reserves portion of the MPC protocol and the declaration of the right to generate a signature corresponding to the signature portion of the MPC protocol, thereby creating a data record representing a transaction stored on the cryptographic registry.

15. The system of claim 1 where the client node is further comprised of memory containing program code that when executed causes the client node to digitally sign at least one messages using the BLS signature scheme and store the signed messages in the cryptographic registry.

16. The system of claim 15 where the validation node is further comprised of memory containing program code that when executed causes the validation node to check the signed messages for proper formulation.

17. A method of transferring a digital crypto asset data object comprising:
generating at a first client node associated with a first user sending the crypto asset, a transfer message data object, said transfer message data object comprised of a transaction right identifier data, and an identifier data of a second client node associated with a second user receiving the crypto asset;
generating at the first client node a digital signature of the transfer message data object;
generating at the first client node an aggregated public key;
writing the transfer message into a cryptographic registry;
receiving at a second client node the transfer message;
verifying at the second client node a public key corresponding to the sender;
generating at the second client node an instance of an aggregated signature; and
generating at the second client node an accept message data object by using the received transfer message and storing the accept message on the cryptographic registry.

18. The method of claim 17 further comprising:
generating at the first client an aggregated public key by using a combination of a BLS public key corresponding to the first client node and a BLS public key corresponding to the second client node.

19. The method of claim 17 where the step of writing the transfer message into the cryptographic registry is further comprised of writing into the cryptographic registry the digital signature of the transfer message, a public key to verify the digital signature of the transfer message, and the aggregated public key.

20. The method of claim 17 further comprising:
receiving at the second client node an ancillary data message comprised of data representing the logical condition that a transfer message has been generated and submitted to the cryptographic registry.

21. The method of claim 20 where the ancillary data message is further comprised of data representing a pointer to a message locator within the cryptographic registry.

22. The method of claim 17 where the step of generating at the second client node an instance of an aggregated signature is comprised of:
generating a digital signature of a plaintext version of the transfer message using the a BLS private key corresponding to the second client; and
generating the aggregated signature by using the digital signature of the transfer message generated by the first client node in combination with the digital signature of the plaintext version of the transfer message generated by the second client node.

23. The method of claim 17 where the step of generating at the second client node an accept message data object is comprised of combining the transfer message with the aggregated signature and the aggregated public key.

24. The method of claim 17 further comprising executing an atomic swap by the first client node writing into the transfer message a transfer of rights from the second client node to the first client node.

25. The method of claim 17 further comprising:
the first client designating at least one additional trustee nodes corresponding to at least one trustees by generating a public message comprised of logical conditions that apply to the at least one trustees and a trustee aggregated public key;
generating at the at least one trustee nodes a public transfer approval message corresponding to the transfer of the digital asset; and
the trustee node storing the public transfer approval message into the cryptographic registry.

26. The method of claim 25 where the public transfer approval message is comprised of a digital signature using a private key from a key pair corresponding to the at least one trustees.

27. The method of claim 26 where the public transfer approval message is comprised of a transaction right identifier and the designation of a secret sharing threshold scheme description.

28. The method of claim 17 further comprising at the first client node, using a secret sharing scheme using a BLS private key from a trustee group for inclusion in a data message stored on the cryptographic registry.
